(19) United States
(12) Patent Application Publication
(10) Pub. No.: US 2011/0042939 A1
(43) Pub. Date: Feb. 24, 2011

(54) Swiveling Preconditioned Air Connector for Aircraft

(75) Inventor: Mark Mustar, Springfield, OH (US)

Correspondence Address: WOOD, HERRON & EVANS, LLP, 2700 CAREW TOWER, 441 VINE STREET, CINCINNATI, OH, 45202, US

(73) Assignee: Twist, Inc., Jamestown, OH (US)

(21) Appl. No.: 12/861,298

(22) Filed: Aug. 23, 2010

Related U.S. Application Data
(60) Provisional application No. 61/236,363, filed on Aug. 24, 2009.

(51) Int. Cl. F16L 55/00

(52) U.S. Cl. 285/148.15

(57) ABSTRACT

A swivel connector for a pre-conditioned air (PCA) hose for an aircraft comprises an inner tube, an outer tube, and a bearing between the inner and outer tube such that an air hose mounted to the inner tube can rotate relative to an aircraft mounting affixed to the outer tube, to remove kinks or twists in the hose without disconnection.

### RELATED APPLICATIONS

The present invention claims priority to U.S. Ser. No. 61/236,363 filed Aug. 24, 2009, the disclosure of which is hereby incorporated herein by reference in its entirety.

### FIELD OF THE INVENTION

The present invention generally relates to ground-based conditioned air systems for aircraft.

### BACKGROUND

It is generally known to supply commercial aircraft with conditioned air for heating and cooling when the aircraft is stationary at a gate. In this application, the term gate is meant to refer to any place that an aircraft receives or discharges passengers or cargo. This may be by way of a telescoping corridor, stairs, or any other facility. Typically, conditioned air is supplied to the aircraft from a pre-conditioned air (PCA) unit that has a ducting system associated with the gate that is a part of the airport terminal. The air is delivered from the gate to the aircraft with a flexible and usually insulated air hose. When not in use, the hose is stored under the terminal. When hooked up to an aircraft the blowers of the PCA are energized, and air flows to the aircraft. This means it is unnecessary for the airplane's fuel powered auxiliary power unit (APU) to produce conditioned air for the stationary aircraft.

A problem exists in that planes arriving at a gate are of different sizes and their hose attachment ports are located at different distances from the gate. Therefore the hose at the gate, having one end connected to the source of preconditioned air, must be at least long enough to service the type of aircraft having its connection point the furthest away. This means that for many arriving aircraft the ground crew is using a longer than necessary hose. The ground crew must attempt to lay the hose along the tarmac in a path that will not result in hose kinks that would decrease the quantity of air delivered. The hose must also stay away from the paths of ground crews and support vehicles. Although the crew attempts to lay the hose in a pattern that will not kink, they are often not successful. Usually they are working with a deflated hose, and the kink does not form until the PCA unit is turned on and the hose inflates. As illustrated in prior art FIG. 1, when a kink 1 is present in a PCA hose 2 hooked to an aircraft 3, a member of the ground crew must unhook the prior art hose connector 4 from the aircraft connector 5 so that the hose can be rotated to remove the kink. Then the hose connector 4 is reattached to the aircraft connector. This is time consuming and involves trial and error.

Previous attempts have been made at solving this problem, for example U.S. Pat. No. 6,182,721 to Gregoryk and published U.S. patent application Ser. No. 11/753,382 to Gosis et. al. are for swivel hose connectors, but these devices have their drawbacks.

### SUMMARY OF THE INVENTION

Previous is needed is an improved connector that either on its own, or with manual help, can swivel so that the hose can be rotated and un-kinked without needing to be disconnected from the aircraft. To that end, a swivel connector having an inner tube adapted for connection to a PCA air hose, and an outer tube adapted for connection to the PCA input connector on an aircraft, are fit together so that the inner tube may rotate while the outer tube is clamped to the PCA input connector on the aircraft.

### BRIEF DESCRIPTION OF THE DRAWINGS

The accompanying drawings, which are incorporated in and constitute a part of this specification, illustrate embodiments of the invention and, together with the general description of the invention given above, and the detailed description given below, serve to explain the principles of the invention.

FIG. 1 is a perspective view of prior art as described in the background section.

FIG. 2 is a perspective view of an embodiment of a swivel connector of the current invention in use.

FIG. 3A is a cross-sectional view of a swivel connector embodiment of the current invention brought in proximity to a connector on an aircraft.

FIG. 3B is FIG. 3A after connection and clamping to the connector on the aircraft.

FIG. 4 is a cross-sectional view as indicated in FIG. 3A.

FIG. 4A is a detail exploded functional view as indicated in FIG. 4.

FIG. 5 is a perspective view of the swivel connector of FIG. 3A.

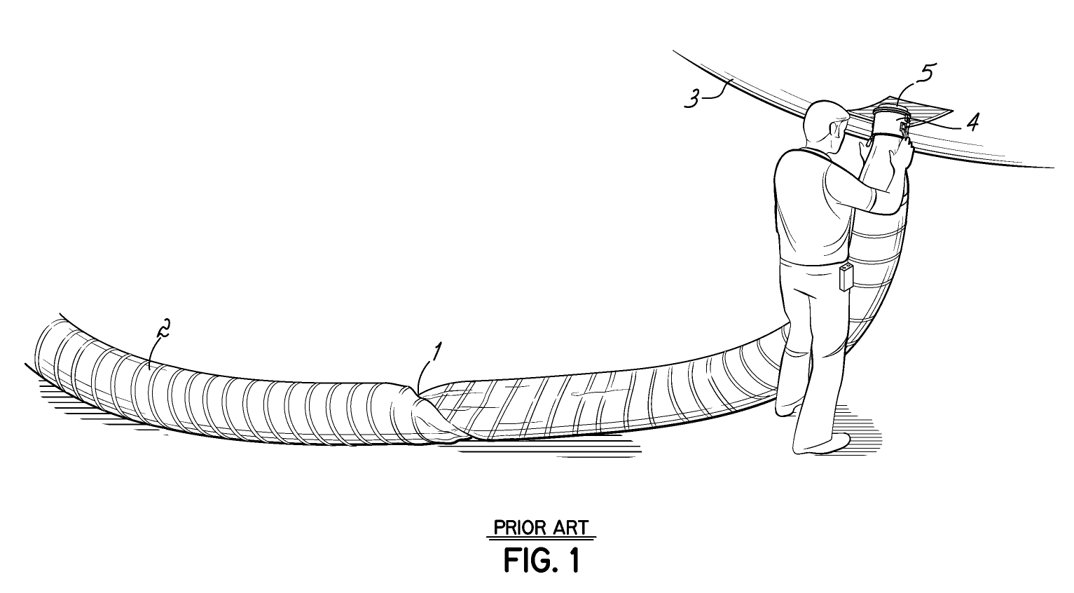

### DETAILED DESCRIPTION

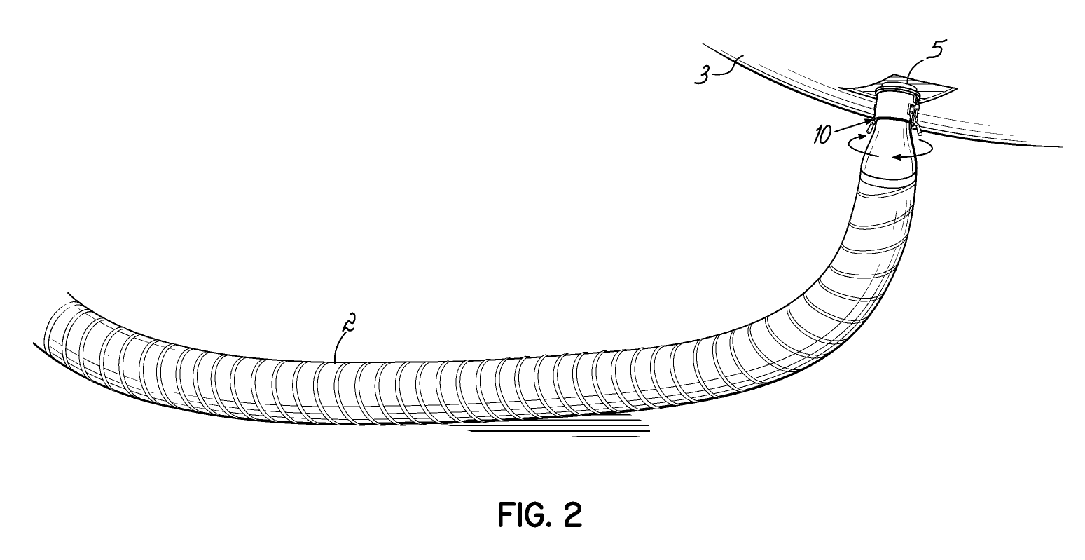

FIG. 2 illustrates a swivel connector 10 on the PCA hose 2 connected to the aircraft 3 at the aircraft connector 5. As indicated by the arrows, the hose rotates relative to the stationary aircraft 3 and aircraft connector 5, so there is no kink in the pca hose 2. Depending upon where the kink is located and other factors such as the temperature and pliability of the hose, this may happen freely from the force of the flowing air. If rotation does not happen freely, then a member of the ground crew may grab the hose and rotate it. It is not necessary to loosen the swivel connector 10 from the aircraft connector 5 to do so. The workings and structure of the swivel connector 10 will be described with reference to the figures that follow.

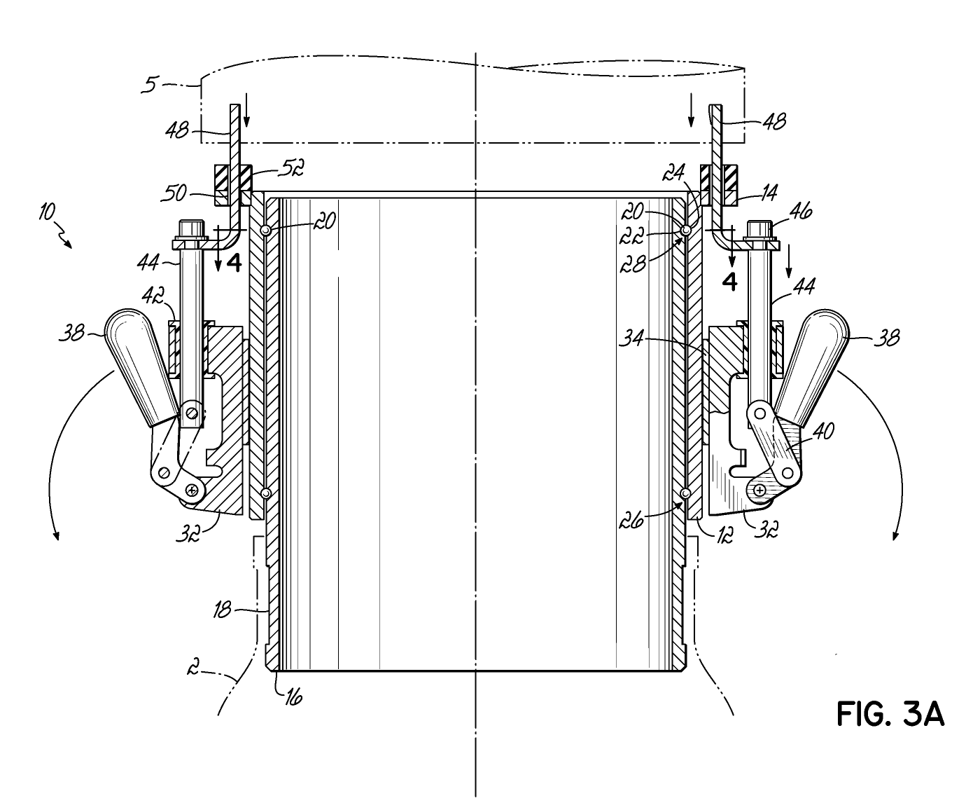

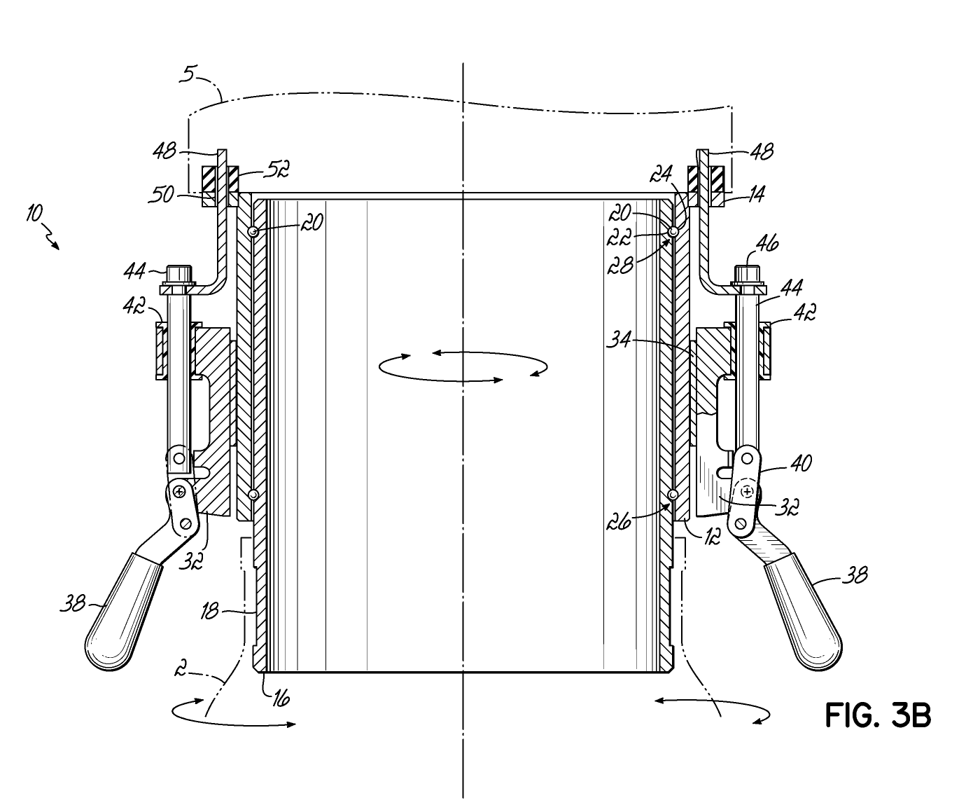

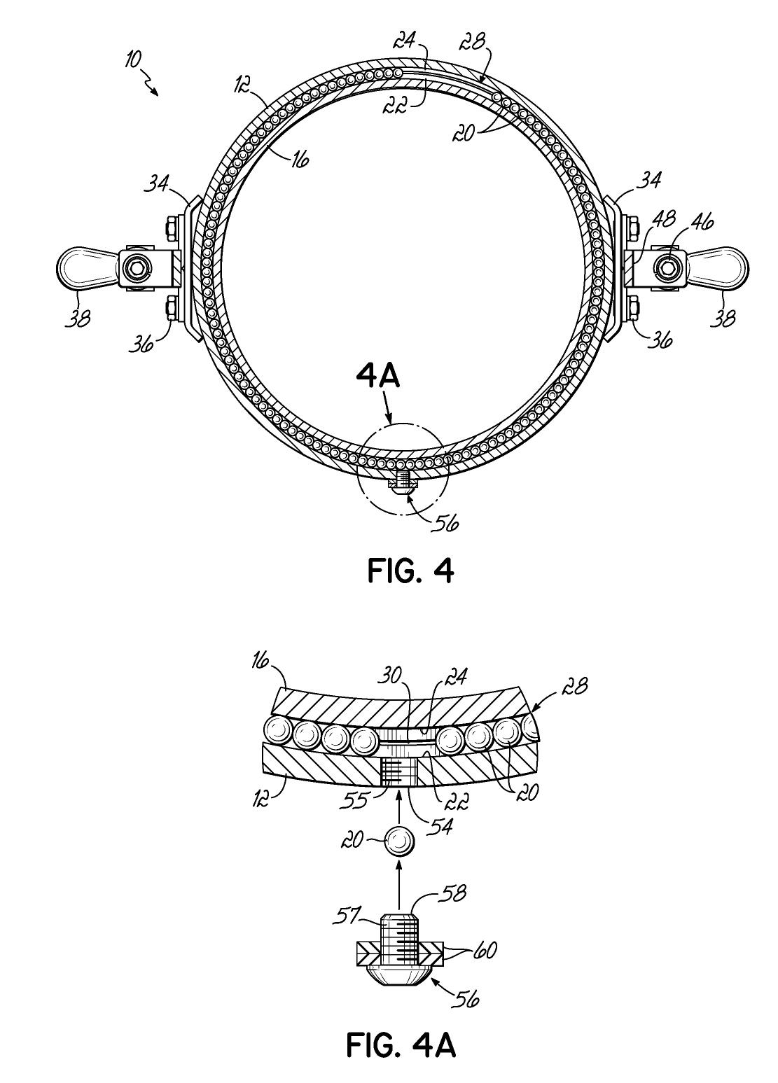

As seen in FIGS. 3A-5, The swivel connector 10 has an outer tube 12 with a flange 14 and an inner tube 16 with a strap recess 18 holding the PCA hose 2 shown in phantom. Between the outer tube 12 and inner tube 16 are stainless steel balls 20 that cooperate with an outer groove 22 in the outside surface of the inner tube 16 and an inner groove 24 in the inside surface of the outer tube 12 to form two bearings, a proximal bearing 26 and a distal bearing 28. In this application the term proximal means in proximity to the source of PCA air, and distal means distant from the source of PCA air. The grooves are acting as inner and outer bearing races. In one embodiment, the inner tube 16 and the outer tube 12 are each made of Aluminum T-6061 material, while the balls 20 are stainless steel. However other materials may also be used. In addition, these assembled-in-place bearings 26, 28 may instead be pressed-in or otherwise preassembled bearings, but this would likely add to the overall bulk of the swivel connector 10. The balls 20 maintain a clearance 30 (FIG. 4A) between the inner tube 16 and outer tube 12. However in other embodiments, where bushings may be used instead of bearings, there might not be any clearance 30. For example, a machined ridge (not shown) integral with the inner tube 16 may slide against the outer tube 12 surface.

Further, although the embodiment described has two ball bearings 26 and 28, other combinations, for example one ball bearing and one cylindrical roller bearing, or one or more bushings in addition to, or in place of bearings, are also within the bounds of the current invention. In addition, the quantity of two is used for an example, and is not limiting.

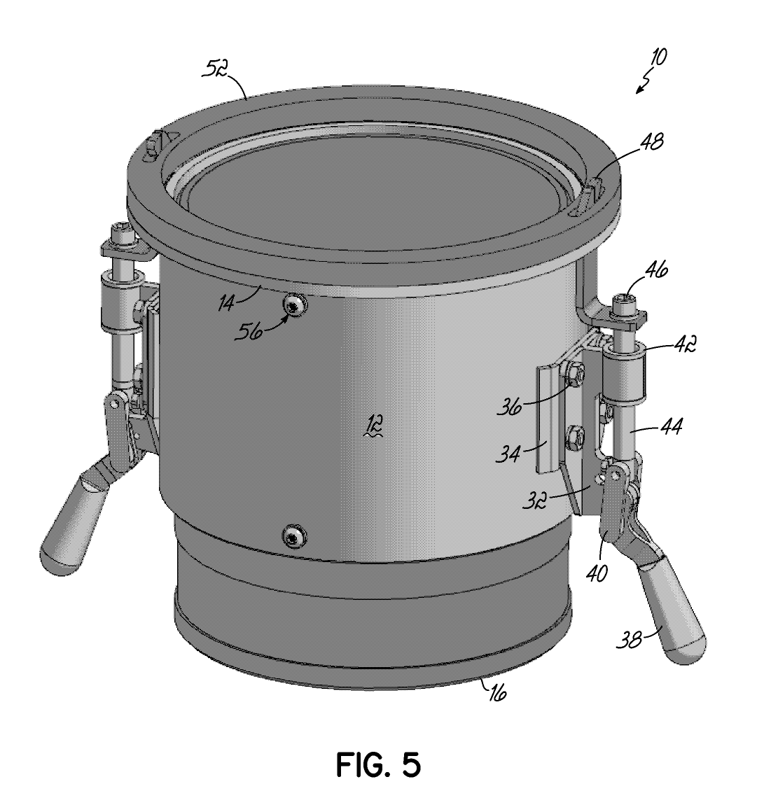

Two clamps 32 are mounted on the outer tube 12 in a way that does not affect the outer tube 12 roundness or interfere with swivel rotation. To that end (FIGS. 4 and 5) the clamps 32 are held to a clamp mount 34 by fasteners 36. The clamp mount 34 is held to the outer tube 12 by welding. This is just one way of attaching the two clamps 32. Other methods of construction would be apparent to one skilled in the art.

The clamps 32 have a handle 38 a link 40 and bushing 42 with an internally threaded shaft 44 passing through the bushing 42. A bolt 46 that passes through a claw 48 is engaged with the threads (not shown) of the shaft 44. The claw 48 passes through the flange 14 at flange slots 50. A gasket 52 is distal of the flange 14 to seal against the aircraft connector 5. In one embodiment, the design of the interface between the aircraft connector 5 and the swivel connector 10 is standardized, and conforms to specification MS33562D.

The inner tube 16 and the outer tube 12 will not separate because the balls 20 in the inner grooves 24 and outer grooves 22 keep them in the fixed relationship.

The swivel connector 10 is assembled by placing the two tubes 12,16 in the relationship shown, and then pouring in the balls 20 through a load port 54 having threads 55. A load plug 56 having threads 57 is tightened in the load port 54 to seal the balls 20 in place. If the load plug 56 is too long, its end 58 would interfere with the movement of the balls 20. If it is too short, it would allow the balls 20 to bump against the edges of the load port 54 as they pass by. For at least those reasons, shims 60 or other devices are used to set the insertion length of the load plug 56. The load port 54, load plug 56, and shims 60 described is just one embodiment of how to load and retain the balls 20. Other ways are contemplated. As with any device used on an airport tarmac, caution is exercised to avoid releasing hard objects that may later be sucked into a jet engine. Appropriate safeguards such as locking features would be used on the fasteners 36 and the load plugs 56.

In use, the handle 38 is first placed in a distal position as seen in FIG. 3A when the ground crew person engages the claws 48 with the aircraft connector 5. Then the ground crew person moves the handles 38 to the position of FIG. 3B, pulling the claws 48 proximally thus causing the outer tube 12 to move distally and squeeze the gasket 52 between the aircraft connector 5 and the swivel connector 10 to make a sealed connection. The threaded connection at the bolt 46 provides adjustability so that the movement of the handle 38 can be set to provide the necessary amount of gasket squeeze. When installed to the aircraft 3, the inner tube 16 may rotate within the outer tube 12 as needed to remove any kinks 1. This rotation may occur freely from the pressure in the PCA hose 2, or may be aided by a ground crew member grabbing the pca hose 2. In some embodiments, the inner tube 16 may have protrusions or other handles so it is not necessary to grab the PCA hose 2.

The invention has been described herein with reference to specific embodiments, and those embodiments have been explained in substantial detail. However, the principles of the present invention are not limited to such details which have been provided for exemplary purposes.

What is claimed is:

1. A swivel connector comprising:
an inner tube adapted for connection to a PCA air hose;
an outer tube adapted for connection to the PCA input connector on an aircraft; and
a rotatable bearing retained between the inner tube and the outer tube to allow the inner tube to rotate while the outer tube is clamped to the PCA input connector.

2. The swivel connector of claim 1 wherein said rotatable bearing comprises balls retained in one or more races located on the inner surface of said outer tube and/or an out surface of said inner tube.

3. A method of improving airflow through a PCA air hose comprising:
removing kinks from the PCA air hose by rotating a first portion of a swivel connector connected to the PCA air hose within a second portion of the swivel connector connected to an aircraft.
